(19) United States
(12) Patent Application Publication
(10) Pub. No.: US 2014/0053285 A1
(43) Pub. Date: Feb. 20, 2014

(54) METHODS FOR DETECTING PLAGIARISM IN SOFTWARE CODE AND DEVICES THEREOF

(71) Applicant: Infosys Limited, Bangalore (IN)

(72) Inventors: Allahbaksh M. Asadullah, Hubli (IN); Srinivas Padmanabhuni, Bangalore (IN); Basava Raju Muddu, Bangalore (IN); Vasudev Damodar Bhat, Hubli (IN)

(73) Assignee: Infosys Limited, Bangalore (IN)

(21) Appl. No.: 13/963,135

(22) Filed: Aug. 9, 2013

(30) Foreign Application Priority Data
Aug. 16, 2012 (IN) 3381/CHE/2012

(51) Int. Cl. G06F 21/10

(52) U.S. Cl. CPC G06F 21/10
USPC 726/32

(57) ABSTRACT

A non-transitory computer readable medium, plagiarism detection device, and method which generate an abstract syntax tree from software code in an computer readable source file, the software code comprising at least one class; identifies one or more method invocations in the source file by means of the abstract syntax tree, and resolves each of the one or more method invocations in the at least one class by acquiring source code associated with each of the one or more invoked methods, where acquiring source code involves identifying at least one node of the abstract syntax tree with which the source code is associated and copying the source code therein and replacing the one or more method invocations in the source file with the copied source code. The source file may be compared with predetermined data, in some embodiments.

This application claims the benefit of Indian Patent Application Filing No. 3381/CHE/2012, filed Aug. 16, 2012, which is hereby incorporated by reference in its entirety.

### FIELD

This technology generally relates to methods and devices for detecting plagiarism in software code and, more particularly, to methods for detecting plagiarism in software code possessing one or more layers of abstraction.

### BACKGROUND

Plagiarism is, in general, the act of copying work authored by another, including writings or, particularly, code, and willfully failing to attribute or acknowledging the original author. Plagiarism is easier to carry out and easier to hide than it has ever been before because of the increasing ubiquity of information and the diversity of information sources available through the internet. To that end, several tools have been developed to detect plagiarism in writings or software code.

Extant tools or techniques for the detection of plagiarism in software code generally operate by means of comparing or matching suspect source code file by file. In some instances, a source code file may be preprocessed or converted to some intermediate form and a matching algorithm that maps the source file to a target file may be applied thereafter. The output of such an operation may generally take the form of a number or a percentage that indicates a degree of plagiarism in the source file.

However, such an approach, absent more, may be unable to efficiently detect plagiarism that is intelligently distributed across multiple source files and obscured by exploiting the structure of the software code. For example, distributing plagiarized material across multiple files in the body of source code may successfully serve to circumvent a plagiarism detection method using a percentage or threshold based output metric by limiting copied material in each of the compared source files to a level below that flagged by the tool. A method for plagiarism detection that can, among other things, address such a scenario is therefore needed.

### SUMMARY

A non-transitory computer readable medium having stored thereon instructions for performing a method of detecting plagiarism in software code is described, which, when executed by at least one processor, causes the processor to perform steps comprising generating an abstract syntax tree from software code in an computer readable source file, the software code comprising at least one class, identifying one or more method invocations in the at least one class in the source file by means of the abstract syntax tree, resolving each of the one or more method invocations in the at least one class, wherein resolving comprises acquiring source code associated with each of the one or more invoked methods by identifying at least one node of the abstract syntax tree with which the source code is associated and copying the source code therein, and replacing the one or more method invocations in the source file with the copied source code, and comparing the source file with predetermined data.

A computing device comprising one or more processors; a memory coupled to the one or more processors, which are configured to execute programmed actions in the memory, comprising: generating an abstract syntax tree from a software code in an computer readable source file, the software code comprising at least one class; identifying one or more method invocations in the at least one class in the source file by means of the abstract syntax tree; resolving each of the one or more method invocations in the at least one class, wherein resolving comprises: acquiring source code associated with each of the one or more invoked methods by identifying at least one node of the abstract syntax tree with which the source code is associated and copying the source code therein; and replacing the one or more method invocations in the source file with the copied source code; and comparing the source file with predetermined data.

This technology provides a number of advantages including providing more effective ways for detecting plagiarism in software code, and more particularly in software code written in an object oriented programming language such as, for example, Java. More specifically, by at least normalizing code that contains multiple layers of abstraction, a cumulative index for plagiarism with respect to a target file may be derived by means of the methods disclosed.

### BRIEF DESCRIPTION OF THE DRAWINGS

FIG. 1 is a block diagram of an exemplary environment which comprises an exemplary computing device for detecting plagiarism, in accordance with an embodiment.

FIG. 2 is a flowchart of a method for detection of plagiarism, in accordance with an embodiment of the present invention.

FIG. 3 is an exemplary class diagram depicting the normalization of multiple method calls, in accordance with an aspect of the present invention.

FIG. 4 is an exemplary class diagram depicting the normalization of a method call to a superclass, in accordance with an aspect of the present invention.

FIG. 5 is an exemplary class diagram depicting the normalization of a method call that returns two or more values, in accordance with an aspect of the present invention.

FIG. 6 is an exemplary class diagram depicting the normalization of a method marked static, in accordance with an aspect of the present invention.

### DETAILED DESCRIPTION

Detecting plagiarism in software code presents a number of complexities; more particularly, plagiarized content may be hidden by exploiting the structure of the software code. For example, in software following an object oriented programming (“OOP”) model, that is, written in an OOPs programming language, copied code may be distributed among multiple classes and methods that share a relationship, with the classes themselves being defined in different source files. Attempts at detection of plagiarized code may be eluded by exploiting class hierarchies in this way, particularly if the detection heuristic is predicated upon a simple percentage match of the source files with some predetermined data.

Examining code across different classes is, therefore, significant in arriving at a reliable detection result. More specifically, removing the abstraction in object oriented code is helpful in detection because such a de-abstraction process may allow the source code to be rendered in a procedural format by making explicit relationships and dependencies in the code, which, therefore, enables reliable comparison of the re-formatted code with the target data.

Methods, devices and computer readable media whereby the present invention may be embodied are described with respect to the following figures and explanations.

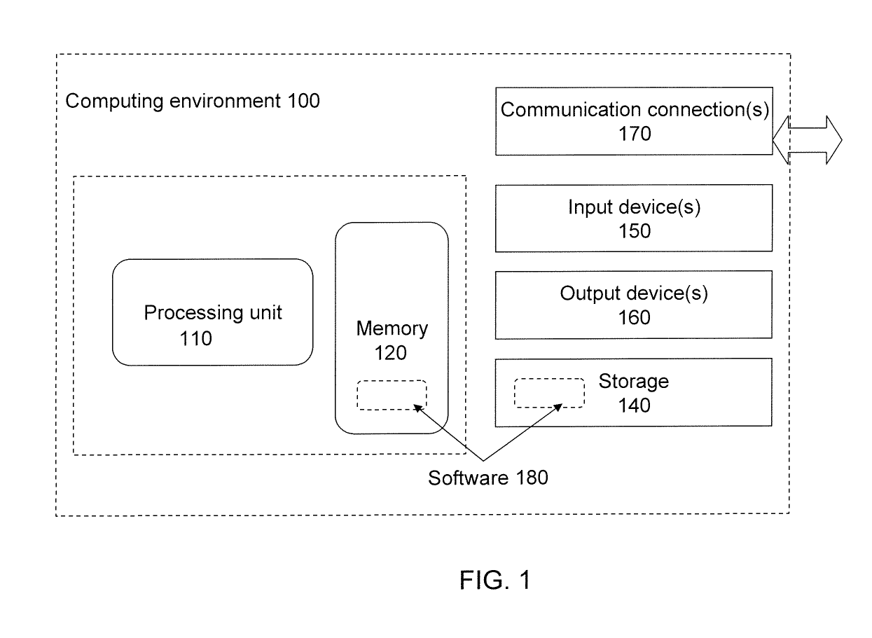

First, an exemplary environment 100 with a computing device comprising a processing unit 110 and a memory that is configured to detect plagiarism in software code is illustrated in FIG. 1. The environment 100 additionally includes at least one communication connection 170, an input device 150, such as a keyboard or a mouse or both, an output device 160, and storage media 160.

The computing environment 100 includes at least one processing unit 110 and memory 120. The processing unit 110 executes computer-executable instructions and may be a real or a virtual processor. In a multi-processing system, multiple processing units execute computer-executable instructions to increase processing power. The memory 120 may be volatile memory (e.g., registers, cache, RAM), non-volatile memory (e.g., ROM, EEPROM, flash memory, etc.), or some combination of the two. In some embodiments, the memory 120 stores software 180 implementing described techniques.

A computing environment may have additional features. For example, the computing environment 100 includes storage 140, one or more input devices 150, one or more output devices 160, and one or more communication connections 170. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The storage 140 may be removable or non-removable, and includes magnetic disks, magnetic tapes or cassettes, CD-ROMs, CD-RWs, DVDs, or any other medium which may be used to store information and which may be accessed within the computing environment 100. In some embodiments, the storage 140 stores instructions for the software 180.

The input device(s) 150 may be a touch input device such as a keyboard, mouse, pen, trackball, touch screen, or game controller, a voice input device, a scanning device, a digital camera, or another device that provides input to the computing environment 100. The output device(s) 160 may be a display, printer, speaker, or another device that provides output from the computing environment 100.

The communication connection(s) 170 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier. Implementations may be described in the general context of computer-readable media. Computer-readable media are any available media that may be accessed within a computing environment. By way of example, and not limitation, within the computing environment 100, computer-readable media include memory 120, storage 140, communication media, and combinations of any of the above.

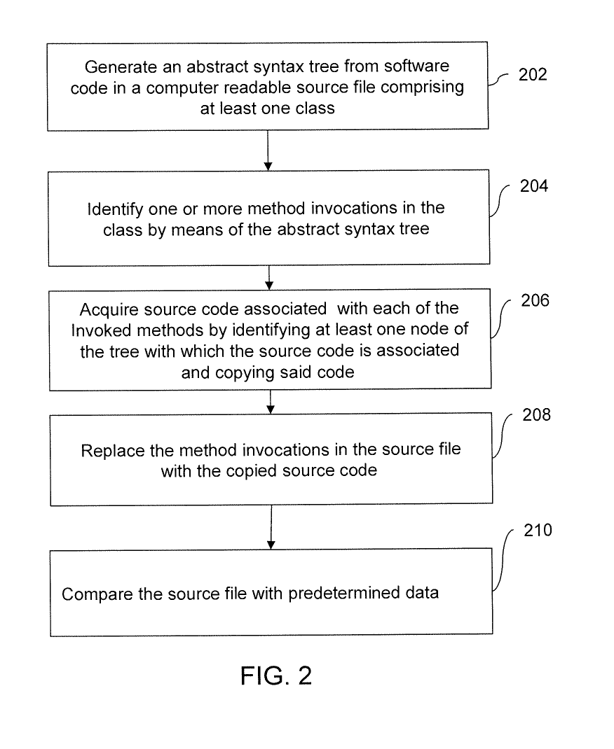

An exemplary method for detecting plagiarism in software code will now be described with reference to FIGS. 2-6.

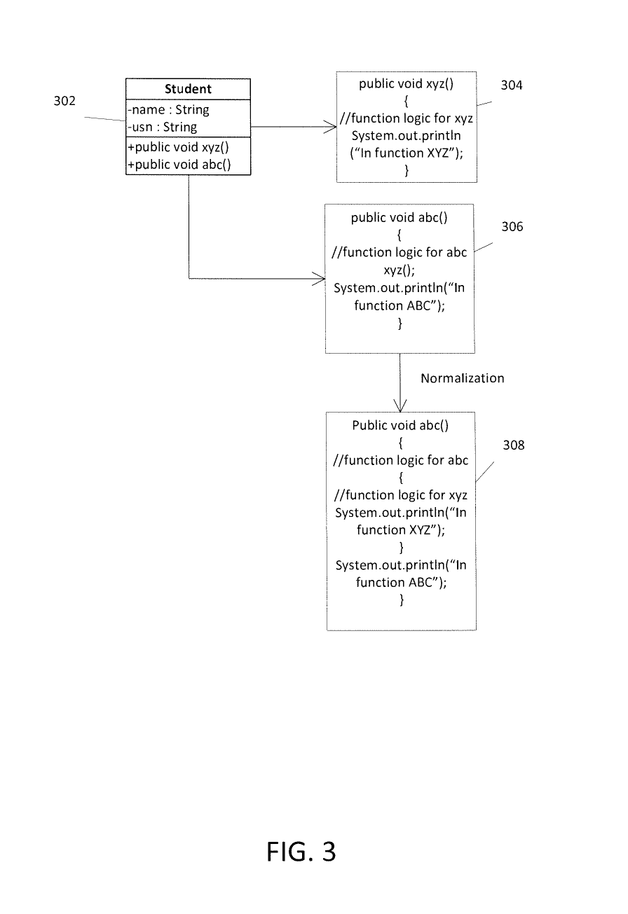

In step 202 of FIG. 2, an abstract syntax tree is generated from software code in a computer readable source file comprising at least one defined class. More specifically, a source file containing the software code to be analyzed for possible plagiarism is received, or is selected by the computing device configured to detect plagiarism. The software code in the received source file is used to construct an abstract syntax tree. An abstract syntax tree, as referred to herein, is a representation of the syntactic structure of the software code in a tree format. Each node of the tree represents an element of the syntax. Nodes may be created by defining a data structure that represents the node and invoking a function that returns a pointer to the structure. Nodes may also have a predetermined set of sub-nodes. Some nodes may be base nodes that comprise one or more sub nodes. For example, a function defined in the software code may be represented as a branch of the abstract syntax tree comprising a base node and one or more sub nodes that represent the defined elements of the function. Referring now to FIG. 3, for example, method calls in the defined classes ‘Student’ 302 and ‘XYZ’ 304, which are expanded upon in 306 and 308, may constitute base nodes, with one or more sub-nodes. A sub-node may represent an attribute, or an object, or an operation or function branching into one or more further sub-nodes, for example. Nodes may also contain information relevant to the syntactic element with which they are associated. In some embodiments of the present invention, nodes of the abstract syntax tree may contain software code.

In step 204, method calls, or invocations, in the classes defined in the source file, are identified by means of the abstract syntax tree. More specifically, the constructed abstract syntax tree may have specific nodes for each element of the syntax of the software code. For example, the abstract syntax tree representation may also comprise nodes for method declarations, base nodes for class declarations, or assignment operations. Illustratively, the parsing of an assignment operation may result in a node branch. For the operation ‘age=a+b’, a node branch may comprise a base node containing ‘age’ and sub-nodes for the left operand, the operator and the right operand.

In step 206, the method calls, or invocations, in the classes are resolved by acquiring source code associated with each of the invoked methods. Method invocations in the acquired source code are identified by examining a node of the abstract syntax tree with which the code is associated, as in 204. More specifically, in 206, the type or nature of the method invocation may be identified, and the source code associated with the invoked methods acquired. For example, if a particular section of code is being used by multiple methods across multiple classes, or is marked with a ‘static’ identifier, the code may be identified as such by a compiler running on the computing device, or converted to a static method by the compiler.

The acquired source code may be obtained by copying, for example copying to a local memory, the software code information in or associated with the nodes of the branch of the abstract syntax tree by which the invoked method is represented. Identifying the type of the method invocation may affect the acquisition of source code. For example, if embodiments are operating on software code written in Java, and a method invocation comprises the keyword ‘super’, the software code associated with the method may be acquired from the parent class in which the method is defined.

The ‘super’ identifier may generally be used to call any public or protected method in a parent class, and may be indicative of a parent-child relationship with the present class and another class. The recognition of inheritance in class relationships by present embodiments is significant in that it enables detection of plagiarized code that is distributed in multiple classes. For example, the copied code may have been split into chunks and distributed across a parent class and a child class that are defined in different source files. Using a ‘super( )’ call or the ‘super’ keyword may then allow an object in the child class to inherit all the data and methods defined in its parent, while a mere comparison of the source file comprising the child class with some target data may not cross a predetermined plagiarism detection threshold since some function logic has been offloaded to the parent.

In step 208, the acquired source code is used to replace the method invocations in the source file. The code may be inserted in the location that the method call is made. In some embodiments, the replacement operation may be performed recursively, in both a horizontal and a vertical direction. Horizontally, method calls made to methods that are present across classes and do not share a relationship may be replaced. For example, if multiple method invocations are identified in the parsed software code for a single class, all the method invocations may be replaced with the acquired software code whereby they are defined. That is, all method calls in a single class may be inlined.

Vertically, calls made to methods defined in two or more classes in a hierarchical relationship may be replaced. The two or more classes may share a parent-child relationship, for example. More specifically, in an illustrative example, if the method called is identified as being defined in a separate class than the method call, replacement of the method call, or invocation, with the acquired source code comprising the method definition is contingent upon the ‘depth’ of method calls in the source code. If a method A( ) calls a method B( ) and B( ), in turn, calls a method C( ), code within B( ) may be used to replace the invocation of B( ) in A( ), but the call to C( ) may be left intact. That is, the software code associated with C( ) may not be in-lined in A( ).

Additionally, if a ‘super’ modifier to an extant method call is identified, as in 206, the method invocation corresponding to the ‘super’ method call may be accordingly replaced with the acquired code that corresponds to its definition.

In step 210, the source file is then compared with predetermined data. The predetermined data may include a user selected file, or files, that are then matched with the modified source file. Matching may involve text matching of the modified source file with the user selected input. The de-abstraction and removal of object oriented constructs extant in the source file may allow for more effective comparison of the software code with the user selected files.

Referring now to FIG. 3, an example normalization of method calls in a class, in accordance with present embodiments, is depicted. Software code across different methods in the same class 302 in a source file is shown, with one method 306 performing a part of a task and transferring control to another method 304 to perform another part of the task. The modified software code 308 in the source file may contain in-lined representations of the methods called. The accumulation of software code split across methods into one location may aid in the detection of plagiarism in comparison with selected data.

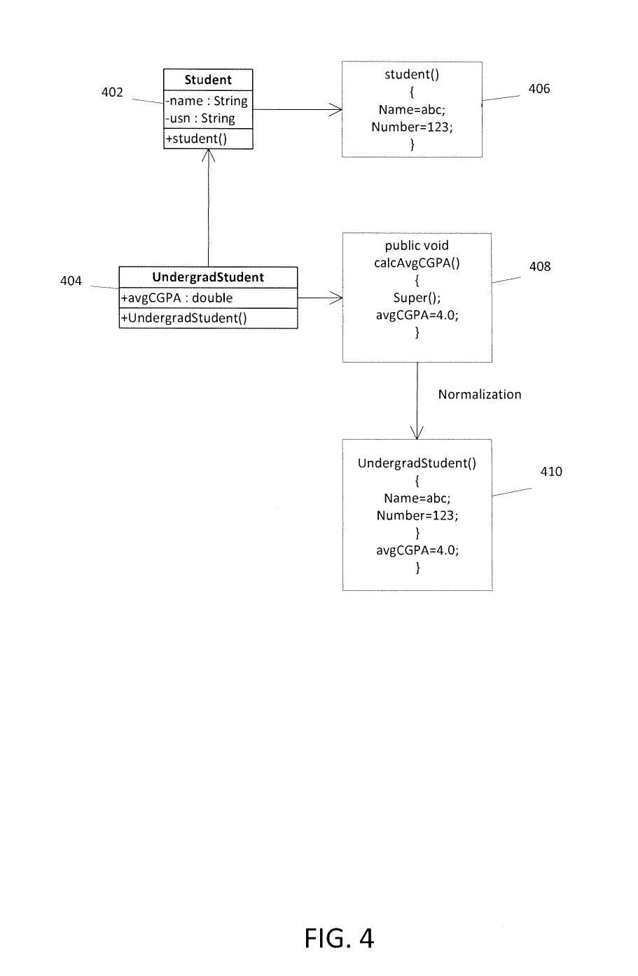

Referring now to FIG. 4, an example normalization of a method call to a parent class, in accordance with present embodiments, is depicted. Class 404 is a child of class 402. Usage of the ‘super( )’ call to hide plagiarized code across the parent and child classes may be detected by inlining calls to methods or constructors that reference the parent class. The method 406 in the parent called by a method 408 in the child class may be inlined in accordance with 410 shown, thereby removing, or de-abstracting, object orientated features in software code in the source file.

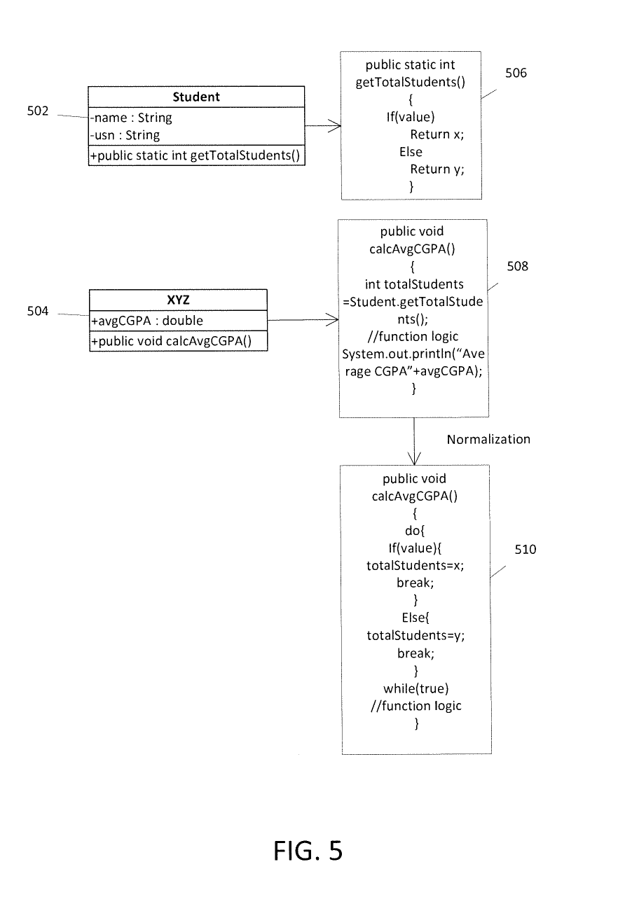

Referring now to FIG. 5, an example normalization of a method call that returns two or more values, in accordance with present embodiments, is depicted. Methods 506 and 508 are defined in classes 502 and 504 respectively. 506 contains conditional logic statements and may return at least one of at least two possible values, and may consequently be inlined as in 510 by present embodiments.

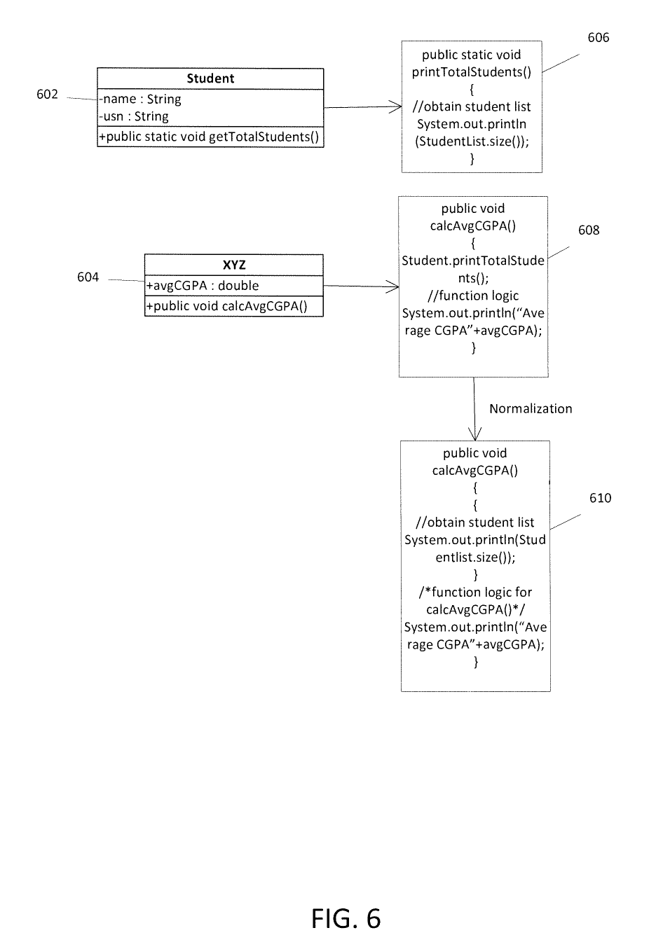

Referring now to FIG. 6, an example normalization of a method marked static, in accordance with present embodiments, is depicted. In such an instance, the method 606, defined in class 602, may be used by multiple methods, such as 608 that exist in classes other than 602, such as 604. Calls to static methods may be inlined by present embodiments such that the copied section of code appears where the call occurs, as in 610, making the code detectable regardless of the purpose for which it is used.

The examples may also be embodied as a non-transitory computer readable medium having instructions stored thereon for one or more aspects of the technology as described and illustrated by way of the examples herein, which when executed by a processor or configurable logic, cause the processor to carry out the steps necessary to implement the methods in the examples, as described and illustrated herein.

Having thus described the basic concept of the invention, it will be apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims.

Accordingly, the invention is limited only by the following claims and equivalents thereto.

What is claimed is:

1. A non-transitory computer readable medium having stored thereon instructions for performing a method of detecting plagiarism in software code, which, when executed by at least one processor, causes the processor to perform steps comprising:
generating an abstract syntax tree from software code in an computer readable source file, the software code comprising at least one class;
identifying one or more method invocations in the at least one class in the source file by means of the abstract syntax tree;
resolving each of the one or more method invocations in the at least one class, wherein resolving comprises:
acquiring source code associated with each of the one or more invoked methods by identifying at least one node of the abstract syntax tree with which the source code is associated and copying the source code therein; and
replacing the one or more method invocations in the source file with the copied source code; and
comparing the source file with predetermined data.

2. The method of claim 1, wherein the software code in the source file comprises at most one class.

3. The method of claim 1, wherein replacing comprises replacing the method invocation with the source associated with invoked method in only the class in which it is called.

4. The method of claim 1, wherein the software code comprises at least two classes, and at least two extant classes possess a parent-child relationship.

5. The method of claim 4, wherein resolving further comprises resolving each invocation of a method defined in the parent class in the child class.

6. The method of claim 1, further comprising identifying a method in the source file that is subject to a method invocation in at least two classes.

7. The method of claim 6, further comprising marking the identified method as static.

8. The method of claim 7, wherein resolving further comprises resolving the static method.

9. A computing device comprising:
one or more processors;
a memory coupled to the one or more processors, which are configured to execute programmed actions in the memory, comprising:
generating an abstract syntax tree from a software code in an computer readable source file, the software code comprising at least one class;
identifying one or more method invocations in the at least one class in the source file by means of the abstract syntax tree;
resolving each of the one or more method invocations in the at least one class, wherein resolving comprises:
acquiring source code associated with each of the one or more invoked methods by identifying at least one node of the abstract syntax tree with which the source code is associated and copying the source code therein; and
replacing the one or more method invocations in the source file with the copied source code; and
comparing the source file with predetermined data.

10. The device of claim 9, wherein the software code in the source file comprises at most one class.

11. The device of claim 9, wherein replacing comprises replacing the method invocation with the source associated with invoked method in only the class in which it is called.

12. The device of claim 9, wherein the software code comprises at least two classes, and at least two extant classes possess a parent-child relationship.

13. The device of claim 12, wherein resolving further comprises resolving each invocation of a method defined in the parent class in the child class.

14. The device of claim 9, further comprising identifying a method in the source file that is subject to a method invocation in at least two classes.

15. The device of claim 14, further comprising marking the identified method as static.

16. The device of claim 15, wherein resolving further comprises resolving the static method.

17. A method for detecting plagiarism, the method comprising:
generating an abstract syntax tree from software code in an computer readable source file by a computing device, the computing device comprising one or more processors and a memory readably coupled thereto, and the software code comprising at least one class;
identifying one or more method invocations, by the computing device, in the at least one class in the source file by means of the abstract syntax tree;
resolving each of the one or more method invocations, by the computing device, in the at least one class, wherein resolving comprises:
acquiring, by the computing device, source code associated with each of the one or more invoked methods by identifying at least one node of the abstract syntax tree with which the source code is associated and copying the source code therein; and
replacing, by the computing device, the one or more method invocations in the source file with the copied source code; and
comparing, by the computing device, the source file with predetermined data.

18. The method of claim 17, wherein replacing comprises replacing the method invocation with the source associated with invoked method in only the class in which it is called.

19. The method of claim 17, wherein the software code comprises at least two classes, and at least two extant classes possess a parent-child relationship.

20. The method of claim 17, wherein resolving further comprises resolving each invocation of a method defined in the parent class in the child class.
